(19) United States
(12) Patent Application Publication
(10) Pub. No.: US 2021/0042210 A1
(43) Pub. Date: Feb. 11, 2021

(54) System and Method Implementing a Mock Server

(71) Applicant: PayPal, Inc., San Jose, CA (US)

(72) Inventors: Cheng Chang, Vancouver (CA); Stanley Chun Ting Fung, Vancouver (CA); Karan Narang, Vancouver (CA); Thilini Rejika Wijesinghage, Vancouver (CA); Lili Xie, Vancouver (CA); Yaroslav Herasym, Vancouver (CA); Shyang-Neng Koong, Vancouver (CA)

(73) Assignee: PayPal, Inc.

(21) Appl. No.: 16/533,327

(22) Filed: Aug. 6, 2019

(51) Int. Cl. G06F 11/36; G06F 9/54; H04L 29/08

(52) U.S. Cl. CPC G06F 11/3664; G06F 11/3612; H04L 67/20; G06F 9/547; G06F 11/3696

(57) ABSTRACT

A system and method for detecting anomalous access to tables is described. Request calls made from an end user to a third-party vendor are received. Responses to the request calls generated by and sent from the third-party vendor to the end user are further received. Relationships between the request calls and the responses are analyzed, and a mock server is built based on this analyzing. The mock server is implemented as a testing platform, where the mock server is able to receive the request calls and provide mock responses.

### TECHNICAL FIELD

The subject technology generally relates to production testing and more particularly, relates to a system and method for implementing a mock server to best accommodate product testing on simulated third-party vendor systems.

### BACKGROUND

User acceptance testing (UAT) is an integral aspect of software development for corporations that conduct electronic transactions. Many of these electronic transactions are conducted online with third-party vendors. During UAT, actual software is tested to make sure it can handle required tasks in real-world scenarios. Software developed within the corporation according to specifications of third-party vendors are thus tested on sandboxed testing platforms that attempt to mimic live transaction performed on the third-party vendor's systems. Typically, this is the last phase of the software testing process that occurs prior to bringing the newly developed software to market.

While testing environments provided by third-party vendors are useful tools for refining new software, they are not without their shortcomings. One issue is that they are owned and thus controlled by the third-party vendors. As such, these testing environments are generally not configurable by the corporations attempting to run the tests. Third-party testing environments can also be inconsistent. For example, a vendor may take down the testing environment for maintenance, or makes changes to the environment that aren't necessarily visible or apparent to the corporations performing the tests. Such activity may create dependability issues when corporations are attempting to run performance tests. Accordingly, there is a need for a system that is capable of implementing mock servers that closely resemble third-party testing environments.

### SUMMARY

According to various aspects of the subject technology, a system for implementing a mock server is described. Request calls made from an end user to a third-party vendor are received. Responses to the request calls generated by and sent from the third-party vendor to the end user are further received. Relationships between the request calls and the responses are analyzed, and a mock server is built based on this analyzing. The mock server is implemented as a testing platform, where the mock server is able to receive the request calls and provide mock responses.

According to various aspects of the subject technology, a method for implementing a mock server is described. Request calls made from an end user to a third-party vendor are received. Responses to the request calls generated by and sent from the third-party vendor to the end user are further received. Relationships between the request calls and the responses are analyzed, and a mock server is built based on this analyzing. The mock server is implemented as a testing platform, where the mock server is able to receive the request calls and provide mock responses.

According to various aspects of the subject technology, a non-transitory machine-readable medium having stored thereon machine-readable instructions executable for implementing a mock server is described. A data log is received from a production testing server. Request calls made from an end user to a third-party vendor are intercepted. Responses to the request calls generated by and sent from the third-party vendor to the end user are further intercepted. The request calls and the responses are analyzed, and a mock server is built based on the received data log and the analyzing. The mock server is implemented as a testing platform, where the mock server is able to receive the request calls and provide mock responses.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a block diagram of an exemplary computing system on which the implementation of a mock server may be performed.

FIG. 2 is a block diagram of an exemplary computer system suitable for implementing one or more devices of the computing system in FIG. 1.

FIG. 3 illustrates an exemplary process 300 for implementing a mock server.

FIG. 4 provides an example configuration of the mock server sitting between an end user and third-party servers.

### DETAILED DESCRIPTION

When corporations perform UAT on software that integrates with third-party vendors, they often perform the tests on sandboxed testing environments provided by the third-party. The sandboxing isolates the tests such that none of the transactions and/or changes get propagated to an actual server. While these testing environments are designed to best mimic live system scenarios, they are only approximate representations of their live counterparts. Thus, the test environment may not provide the appropriate platform for testing certain situations (e.g., stress test, latency test, throughput test, etc.).

Additionally, since these testing environments are owned and controlled by the third-party vendors. Those who perform testing on these platforms, on the other hand have little to no control over the configuration of the testing environments. Accordingly, testers may be required to contact the third-party vendors to have the testing environment specially configured to represent specific scenarios that can't otherwise be achieved. Testers may also face the occasional downtime of these environments and have few, if any, options other than to wait out the downed servers. Furthermore, changes on the testing environment often occur without any announcement, and these changes may result in a new set of responses. Without visibility into what these changes are and when they're implemented, unexpected results may surface during testing that require further inspection, thereby interrupting a testing cycle.

In order to serve better serve the needs of a corporation, a mock server may be implemented. The proposed mock server has visibility to all communication that occurs across third-party vendor application programming interface (API) endpoints. In other words, the mock server monitors requests sent by the tester and the corresponding responses returned from the vendors over some period of time. Analysis of the communication across the endpoints (e.g., by using machine learning) allows the mock server to create a testing environment that closely resembles the environment being monitored. The mock server can rely on the data collected from both sandboxed testing and live environments since the mock server can monitor all types of communication. More importantly, the mock server can be configurable by the tester, thereby providing added flexibility in terms of the types of responses that may be generated in test scenarios. This ability to directly control the environment allows the tester to more comprehensively and efficiently test software before bringing the product to market.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.). Furthermore, various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

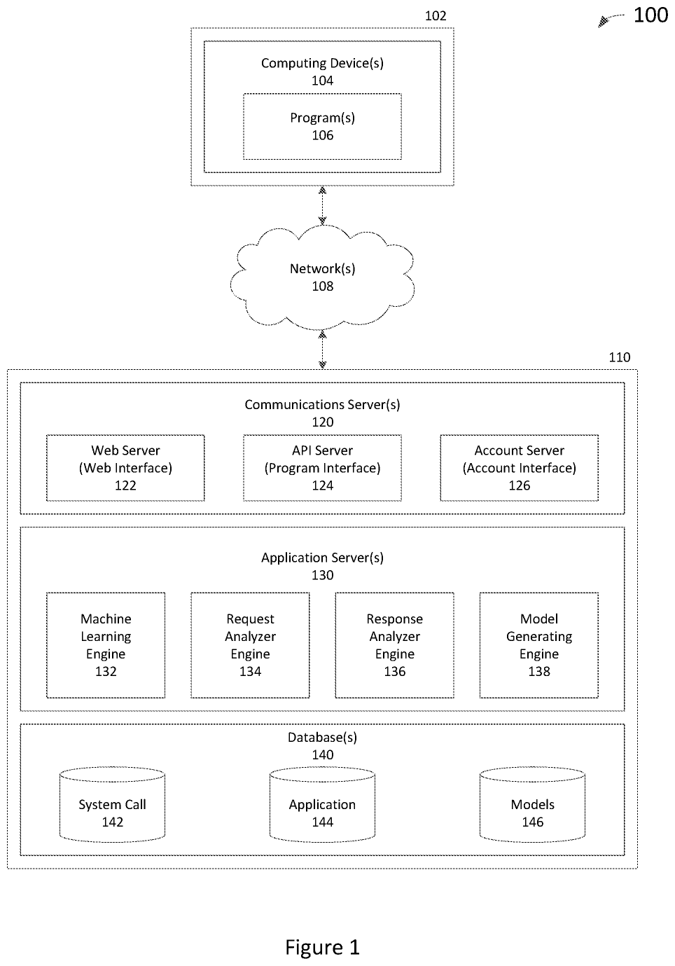

FIG. 1 is a block diagram of an exemplary computing system on which the implementation of a mock server may be performed. As shown, a computing system 100 may comprise or implement a plurality of servers, devices, and/or software components that operate to perform various methodologies in accordance with the described embodiments. Exemplary servers, devices, and/or software components may include, for example, stand-alone and enterprise-class servers running an operating system (OS) such as a MICROSOFT® OS, a UNIX® OS, a LINUX® OS, or other suitable OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, client devices, databases and other elements, one or more servers 102 comprising or employing one or more computing devices 104. Computing devices 104 may provide one or more programs 106, such as system programs and application programs to perform various computing and/or communications operations. Exemplary system programs may include, without limitation, an operating system (e.g., MICROSOFT® OS, UNIX® OS, LINUX® OS, Symbian OS™, iOS, Android, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a payment system application, a web browser application, messaging application, contacts application, calendar application, electronic document application, database application, media application (e.g., music, video, television), location-based services (LBS) application (e.g., GPS, mapping, directions, positioning systems, geolocation, point-of-interest, locator) that may utilize hardware components such as an antenna, and so forth. One or more of client programs 106 may display various graphical user interfaces (GUIs) to present information to and/or receive information from one or more users of client devices 104. In some embodiments, client programs 106 may include one or more applications configured to conduct some or all of the functionalities and/or processes discussed below.

As shown, computing devices 104 may be communicatively coupled via one or more networks 108 to a network-based system 110. Network-based system 110 may be structured, arranged, and/or configured to allow client 102 to establish one or more communications sessions between network-based system 110 and various client devices 104 and/or client programs 106. Accordingly, a communications session between client devices 104 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data communications between computing devices 104 and the network-based system 110 may be sent via API endpoints over one or more networks 108 such as the Internet, a WAN, a WWAN, a WLAN, a mobile telephone network, a landline telephone network, personal area network, as well as other suitable networks. For example, computing devices 104 may communicate with network-based system 110 over the Internet or other suitable WAN by sending and or receiving information via interaction with a website, e-mail, IM session, and/or video messaging session. Any of a wide variety of suitable communication types between computing devices 104 and system 110 may take place, as will be readily appreciated. In particular, wireless communications of any suitable form (e.g., Bluetooth, near-field communication, etc.) may take place between computing device 104 and system 110, such as that which often occurs in the case of mobile phones or other personal and/or mobile devices.

Network-based system 110 may comprise one or more communications servers 120 to provide suitable interfaces that enable communication using various modes of communication and/or via one or more networks 108. Communications servers 120 may include a web server 122, an API server 124, and/or a messaging server 126 to provide interfaces to one or more application servers 130. Application servers 130 of network-based system 110 may be structured, arranged, and/or configured to provide various online services to client devices that communicate with network-based system 110. In various embodiments, client devices 104 may communicate with application servers 130 of network-based system 110 via one or more of a web interface provided by web server 122, a programmatic interface provided by API server 124, and/or a messaging interface provided by messaging server 126. It may be appreciated that web server 122, API server 124, and messaging server 126 may be structured, arranged, and/or configured to communicate with various types of client devices 104, and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, mobile applications, and so forth. API server 124 may be arranged to communicate with various client programs 106 comprising an implementation of API for network-based system 110. Messaging server 126 may be arranged to communicate with various messaging clients and/or applications such as e-mail, IM, SMS, MMS, telephone, VoIP, video messaging, IRC, and so forth, and messaging server 126 may provide a messaging interface to enable access by client 102 to the various services and functions provided by application servers 130.

Application servers 130 of network-based system 110 may be servers that provide various services such as tools for verifying URLs based on information collected about customers. Application servers 130 may include multiple servers and/or components. For example, application servers 130 may include a machine learning engine 132, request analyzer engine 134, response analyzer engine 136, and/or model generating engine 138. These servers and/or components, which may be in addition to other servers, may be structured and arranged to implement a mock server.

Application servers 130, in turn, may be coupled to and capable of accessing one or more databases 140 including system call database 142, application database 144, and/or models database 146. Databases 140 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

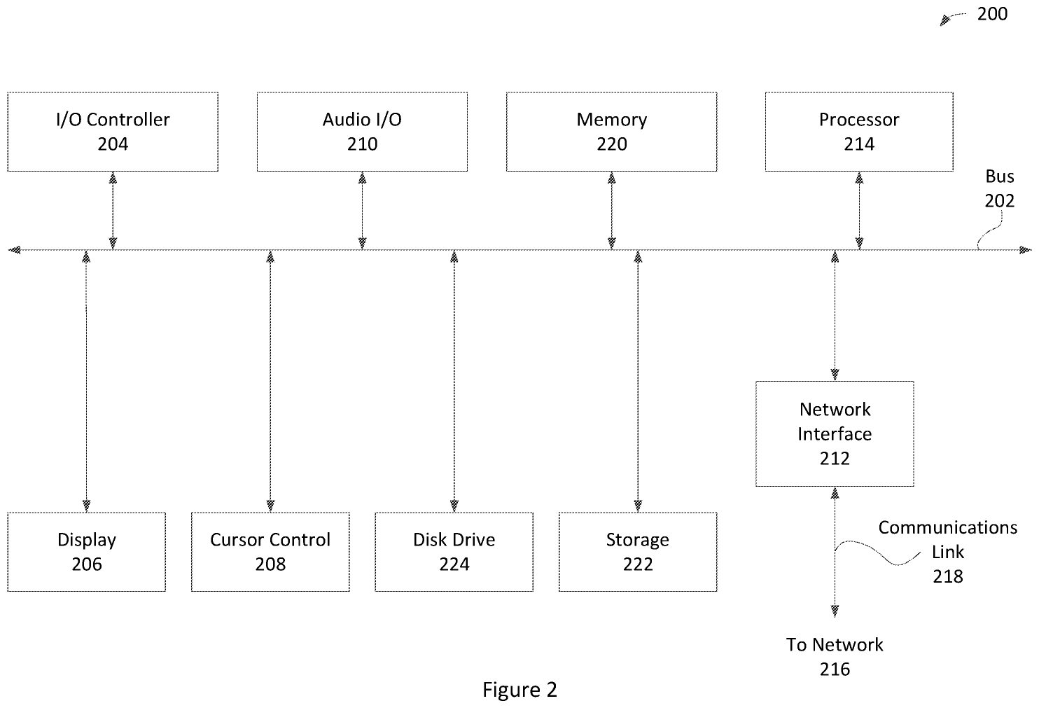

FIG. 2 illustrates an exemplary computer system 200 in block diagram format suitable for implementing on one or more devices of the computing system in FIG. 1. In various implementations, a device that includes computer system 200 may comprise a personal computing device (e.g., a smart or mobile phone, a computing tablet, a personal computer, laptop, wearable device, PDA, etc.) that is capable of communicating with a network. A service provider and/or a content provider may utilize a network computing device (e.g., a network server) capable of communicating with the network. It should be appreciated that each of the devices utilized by users, service providers, and content providers may be implemented as computer system 200 in a manner as follows. Additionally, as more and more devices become communication capable, such as smart devices using wireless communication to report, track, message, relay information and so forth, these devices may be part of computer system 200.

Computer system 200 may include a bus 202 or other communication mechanisms for communicating information data, signals, and information between various components of computer system 200. Components include an input/output (I/O) controller 204 that processes a user action, such as selecting keys from a keypad/keyboard, selecting one or more buttons, links, actuatable elements, etc., and sends a corresponding signal to bus 202. I/O controller 204 may also include an output component, such as a display 206 and a cursor control 208 (such as a keyboard, keypad, mouse, touchscreen, etc.). In some examples, I/O controller 204 may include an image sensor for capturing images and/or video, such as a complementary metal-oxide semiconductor (CMOS) image sensor, and/or the like. An audio I/O component 210 may also be included to allow a user to use voice for inputting information by converting audio signals. Audio I/O component 210 may allow the user to hear audio.

A transceiver or network interface 212 transmits and receives signals between computer system 200 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 214, which may be a micro-controller, digital signal processor (DSP), or other processing component, processes these various signals, such as for display on computer system 200 or transmission to other devices over a network 216 via a communication link 218. Again, communication link 218 may be a wireless communication in some embodiments. Processor 214 may also control transmission of information, such as cookies, IP addresses, images, and/or the like to other devices.

Components of computer system 200 also include a system memory 220 (e.g., RAM), a static storage component 222 (e.g., ROM), and/or a disk drive 224. Computer system 200 performs specific operations by processor 214 and other components by executing one or more sequences of instructions contained in system memory 220. Logic may be encoded in a computer-readable medium, which may refer to any medium that participates in providing instructions to processor 214 for execution. Such a medium may take many forms, including but not limited to, non-volatile media, volatile media, and/or transmission media. In various implementations, non-volatile media includes optical or magnetic disks, volatile media includes dynamic memory such as system memory 220, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

One mechanism that can be implemented to provide the most robust and comprehensive software testing and speed up release cycles and to is the mock server. By providing an environment that closely mimics that of vendor test platforms and that is configurable by a tester, the mock server is a valuable tool that's utilized during a production cycle for testing purposes.

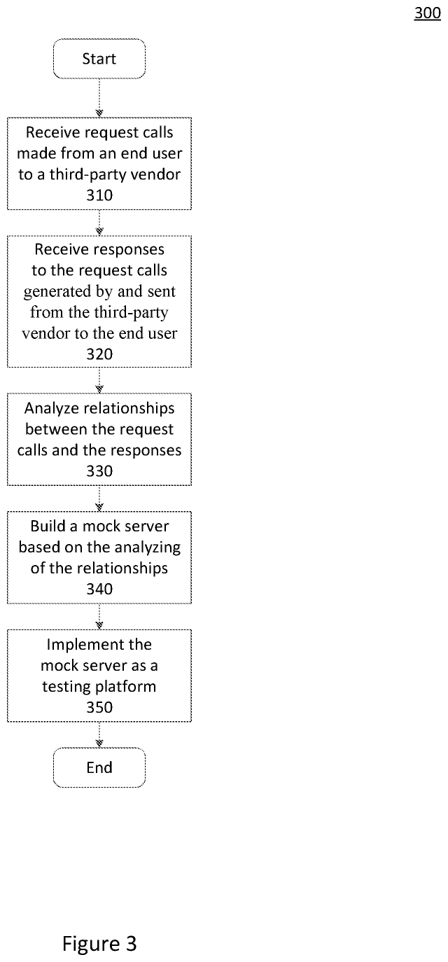

FIG. 3 illustrates an exemplary process 300 for implementing a mock server according to one embodiment. In step 310, a request being sent to a third-party vendor is received by the mock server system. The request sent to the vendor may include a query for an account (e.g., user logs into an account to see an account balance). Such a query is typically packaged based on specifications provided by the vendor so that the request can be properly communicated over the vendor's API endpoints. In some embodiments, the request may include information like an account identification (ID), a password, and the information requested. In some embodiments, the request is sent during UAT by a computing device that is performing a test. Typically, these types of test requests are sent to a testing environment operated by the vendor. Alternatively, the request by be an actual live request that originated from an actual user. These types of requests are sent to the live server along with all other “real” traffic.

Once sent to and processed by the vendor, a response is typically generated and returned back to the requester. The request may be processed by the live server or the test environment. At step 320, this response is received by the system. Further to the example presented above, the response may include the account ID and the account balance associated with the account ID.

Once the request and response have been received, the information is analyzed in step 330. In order to build the mock server, many requests and responses are received and processed. After the many requests and responses are received, analyses can be run to detect patterns in the request-response pairs. In some embodiments, machine learning may be used to detect patterns based on the request-response pairs. Furthermore, as the number of requests and responses grow, so does an index that contains all of the requests and responses so that a universe of these requests and responses can be defined.

At step 340, the mock server is implemented based on the analysis of the requests and responses. The logic of the mock server may be dependent on the analyses of the request, response pairs. For example, if every instance of request x generates a response y, then the mock server will be designed to return response y each request x is received as an input. This simplistic example is provided to demonstrate the relationship between requests and responses in the construction of a mock server. In reality, the relationships can be considerably more advanced as the construction and implementation of the mock server will take into the complex interdependencies of the requests and responses. For example, a specific sequence of requests may cause one response to be generated, while the same requests sent in another sequence may cause a different response to be returned. A host of other information and conditions may also be taken into account (e.g., requests from production server logs, requests from software development kit documents, and scrubbed user information database).

Once the mock server has been implemented, the mock server can take in different requests and provide corresponding responses in a similar manner as the testing environments provided by third-party vendors. One example is integration with a prepaid card vendor scenario. Typically, testing is performed by a quality assurance (QA) environment on the company side transacting with a vendor provided sandboxed test environment. In such a scenario, the QA environment may be instructed to send an API call to the vendor (e.g., request that a prepaid card be created). Other requests to such a vendor may include a requests to cash out the balance, present an account balance, show a transaction history, etc. That is, the vendor may provide a full suite of features that one would expect from a prepaid card vendor. The request is then processed by the test environment and a response is generated and sent back to the QA environment on the company side.

While the exemplary process in FIG. 3 describes receiving requests and responses, the mock server effectively intercepts and passes on these requests and responses to the corresponding component. The mock server is able to gather information from the intercepted the requests and responses to construct a model representative of the vendor test environment. These requests and responses are inspected to facilitate the replication process. Part of this process further includes identifying and then following the specifications used by the vendor test environment so that the mock server could closely mimic the third-party test platform. In some embodiments, an inventory of the APIs supported by the vendor may be maintained by the mock server.

The primary purpose of the mock server is to replicate responses to requests. For example, responses to the requests are replicated based on the APIs provided by the vendor. While the objective is to create as similar a copy of the vendor's environment (e.g., vendor's test environment and/or live environment) as possible, it may be impractical or inefficient to do so. As such, certain responses to requests may be simplified. That is, some fields may made be static so that the same response is the same for all queries made on that field. One example may be to make the account number or name of the account holder be the same value for every inquiry presented to the mock server. These fields may be made static to streamline the mock server, as keeping these values static may be of little to no consequence to testing. Specifically, the mock server only needs to ensure that a proper value is retuned so as to not trigger a fault.

In some embodiments, it may be important to persist data to a database on the mock server. For example, a vendor database may maintain account balance info for an account holder. Thus, when a deposit is made to or withdrawal is made from the account, that data is persisted to the database to ensure accuracy. Accordingly, the mock server may replicate the vendor's database schema based on what's viewable from the vendor's side in this embodiment. That is, a set of endpoints may be generated to provide an interface similar to that which is used by the third-party vendor. When a transaction results in a chance in value on the database, such information is communicated through the mock endpoints and persisted onto the database. These endpoints exist as internal endpoints and replicate third-party endpoints.

In some embodiments, the mock server may include compliance/know your customer (KYC) endpoints. Since actual sanction lists of users may not be made available or maintainable for testing, fabricated data may be created to run tests with regards to KYC. For example, instead of using actual personally identifiable information (PII), such as names, dates of birth, and social security numbers, mock data may be created for the purpose of testing. Using mock data also adds an element of security in case the mock server is compromised in that no PII would be leaked.

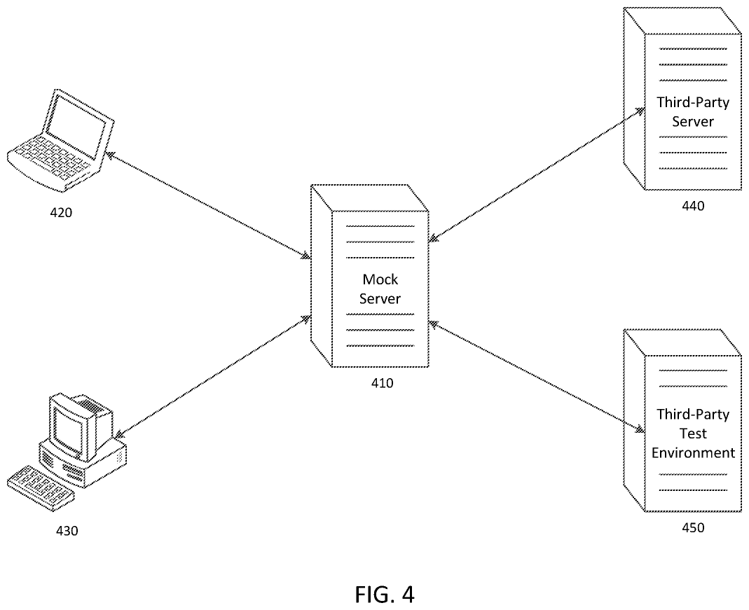

One aspect of the mock server that enhances its usability is its ability to provide controls to the tester/user. As shown in FIG. 4, the mock server 410 may sit in between a third-party test environment 450 and a production environment 430 of a corporation. Alternatively or additionally, the mock server 410 may sit between an end user 420 and an actual live third-party server 440. In other words, the mock server 410 serves as proxy in between the components so that it may solve reliability as well as other problems.

One benefit of having control over the mock server is that there would no reliance on the third-party vendor to run certain scenarios. Instead, these scenarios can be set within the mock server by the tester to provide any the response in any manner desired. In other words, testers no longer would be required to go through an entire scenario to arrive at a state. By controlling the mock server, the tester can simply force that state. This type of control provides for testing any variety of error responses that have been provided by vendor at any time. The tester simply lets the mock server know what scenario he wants to test, and the mock server can return a chain of responses that duplicates that scenario. This option facilitates the learning process for testers to figure out how to handle certain scenarios.

In some examples, the mock server can generate more than just responses to requests. In certain instances, mock server may trigger certain actions without receiving a request. Returning to the card issuer example, a card holder may call into customer service to report a stolen or missing card. This may trigger an action that isn't a response to a request received via an API call. This type of action may not always be available on a vendor's test environment since those environments are generally designed to be reactive to requests. Accordingly, certain calls within application cannot be mocked as they are not exposed during testing. Instead, if a mock environment is privy to such action, the mock server can be configured to triggers these actions, either periodically or on command.

As discussed above with reference to FIG. 4, the mock sever doesn't only collect information during testing on a vendor test environment, but may also collect information during live transactions on the actual live third-party server. As such, the mock server may be privy to the actions that aren't necessarily reactive to a received requests (i.e., the types of actions that are seen during testing). Ultimately, the mock server is exposed to a comprehensive set of data that may be used to improve on the model. Additionally, the mock server may build knowledge off documentation provided by the vendors. Such documentation may describe states that are rarely or never seen during testing. If those states are never seen, then testing won't provide the comprehensiveness for new software to handle such states when they do appear during live transactions.

On occasion, the documentation provided by the vendor may be wrong. Furthermore, vendors may change the configuration or specifications of the testing environment without communicating the change to the testers. When vendors change APIs, it's not uncommon for testers to notice this change only when a test breaks. In such situations, an inspection of the actual sandbox calls and responses can be made and compared to documentation provided. Ultimately, the documentation is a living document. That is, if vendors change something on their test environment, a tester that utilizes a mock server can reference back and inquire with the vendor about the change.

In some embodiments, logs on from production can be used to facilitate the building of the mock server. The logs provide a representation of historical transactions between production and the test server. Since such logs may be available at the time the mock server is built, the logs can be utilized in much the same way as the requests and responses that are intercepted during testing and live transactions. In other words, these logs may include data that would have been collected by the mock server had the mock server existed at the time the logs were recorded.

Additionally, the mock server can be updated or tweaked based on production feedback. In other words, production may provide information directly to the mock server regarding production's direct interaction with the test environment. As such, the mock server may not necessarily need to interact with the test environment, and may deduce the transactions from the perspective of production.

In some embodiments, the mock server can be configured to execute performance tests. Vendor test environments generally do not consider performance tests because UATs are not performed on actual live servers and do not produce a normal flow of traffic. In fact, the UAT gateway is limited. The mock server, on the other hand, may be configured by modeling throughput based on response times extracted from live transactions. For example, if actual response times are five per second, then the mock server can be configured to handle 5 transactions per second so that software can be optimized on the mock server based on this metric.

In an alternative embodiment, the mock server can be enhanced in a manner so that the maximum performance of a software program can be determined. In other words, enough resources may be dedicated to the mock server so that the performance of the mock server doesn't max out before the performance of the software being tested. As such, the tester can identify the upper limits of the software in an ideal environment. Doing so may help a tester identify issues that may arise from unusually high traffic. It may also help a corporation determine whether an upgrade in software, hardware, or even third-party vendor may be required to be able to properly serve its clients.

On the other end of the spectrum, the mock server may be dialed down in performance so that software may be tested for situations where a vendor's servers are overwhelmed with traffic. Accordingly, instead of flooding a test environment with requests (which may require additional resources) to overwhelm a test environment, the mock server can be scaled down to reduce the amount of traffic it can handle and the amount of traffic required to overwhelm the system. As such, a modest number of requests may cause the mock server to respond as if being overwhelmed. Creating such an environment reduces the amount of resources required to perform such a stress test. It can also reduce the amount of time that's required to perform a test as some large scale tests may take hour or even days to perform. By scaling the mock server down, a test to procure the necessary information may be performed in a significantly more expeditious manner.

In some embodiments, templates of mock servers may be created. These templates may have a universal underlying structure, but also provide certain elements of customization. By providing some customization capabilities, the templates may be fine-tuned to adapt to environments of a number of different vendors. For example, the mock server may be designed to use a number of building blocks that can be dropped in as generic components. Depending on the vendor the mock server is attempting to mimic, a different combination of components may be added.

One of the benefits of the mock server is that it sits between production testing/end user on one side, and live third-party server/test environment on the other side. As such, the mock server is able to not only be based on the test environment, but it is also able to utilize information extracted from live transactions. Accordingly, the mock server can determine a delta between the two environments and ping the third-party vendor if any significant differences are identified. Such differences can be an indication of an underlying issue with the test environment, and/or that the test environment needs an update. Other differences may be an indication of performance drifts from the actual server to the test environment that are caused by potential hardware issues.

By monitoring the requests and responses exchanged between the corporation and the vendor (whether on the live or test environment), the mock server is also able to obtain a high resolution look into the transactions. As such the mock server could identify a universe of states that may be entered into based on the sequence of transactions. In doing so, the mock server may identify new states that were not known to exist previously. For example, a system may detect that a specific state (e.g., state seven) has been entered into.

Based on a history of transactions, it may be determined that there are many paths that can get the system to arrive at state sever. Since all these paths may be recorded/save, the system can run all the paths on the mock server to determine whether or not there may be more than one state sever. In other words, with the help of the mock server, it may be determined that state seven isn't in fact just one sate, but multiple states that appear to be the same. Thus, but analyzing the different paths to state seven, and analyzing the many paths that extend from state seven, the system may identify a pattern that certain paths into state seven results in certain paths out of state seven. Such discovery of unique paths that were previously unknown is crucial during QA testing.

Ultimately, the mock server offers added elements of dependability and flexibility to the UAT process. By making comprehensive observations of the transactions between corporations and vendors, the mock server is able to be configured into a powerful model that not only closely represents live environments, but is able to provide detailed feedback for troubleshooting on the corporation side as well as the vendor side. Also, by cutting out the need to submit requests to vendors to test specific situations, and by being able to force any known state on command, the mock server can also drastically accelerate the testing process. As such, corporations are equipped with the capability to bring newly developed software to market in an expeditious manner.

The user device (i.e., the computing device) described above may be one of a variety of devices including but not limited to a smartphone, a tablet, a laptop and a pair of augmented reality spectacles. Each of these devices embodies some processing capabilities and an ability to connect to a network (e.g., the internet, a LAN, a WAN, etc.). Each device also includes a display element for displaying a variety of information. The combination of these features (display element, processing capabilities and connectivity) on the mobile communications enables a user to perform a variety of essential and useful functions.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples of the disclosure. A phrase such an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the terms “include,” “have,” and “the like” are used in the description or the claims, such terms are intended to be inclusive in a manner similar to the term “comprise” as “comprise” is interpreted when employed as a transitional word in a claim.

The word “exemplary” is used herein to mean “serving as an example, instance, or illustration.” Any implementation described herein as “exemplary” is not necessarily to be construed as preferred or advantageous over other implementations.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A system for implementing a mock server comprising:
a non-transitory memory storing instructions; and
one or more hardware processors coupled to the non-transitory memory and configured to read the instructions from the non-transitory memory to cause the system to perform operations comprising:
receiving request calls made from an end user to a third-party vendor;
receiving responses to the request calls generated by and sent from the third-party vendor to the end user;
analyzing relationships between the request calls and the responses;
building a mock server based on the analyzing; and
implementing the mock server as a testing platform, the mock server being able to receive the request calls and provide mock responses.

2. The system of claim 1, wherein the request calls are made by the end user in a production environment.

3. The system of claim 1, wherein the request calls are made and the responses are received as part of a user acceptance testing.

4. The system of claim 1, wherein the responses to the request calls are generated by a test environment of the third-party vendor.

5. The system of claim 1, wherein analyzing the relationships between the request calls and the responses comprise detecting patterns in the responses in relation to the request calls.

6. The system of claim 1, wherein the operations further comprise receiving, from the third-party vendor, a specifications list, wherein the mock server is built further based on the received specification list.

7. The system of claim 1, wherein the mock server, when implemented, provides endpoints through which the end user may communicate.

8. A method for implementing a mock server comprising:
receiving request calls made from an end user to a third-party vendor;
receiving responses to the request calls generated by and sent from the third-party vendor to the end user;
analyzing relationships between the request calls and the responses;
building a mock server based on the analyzing; and
implementing the mock server as a testing platform, the mock server being able to receive the request calls and provide mock responses.

9. The method of claim 8, further comprise receiving, from the third-party vendor, a specifications list, wherein the mock server is built further based on the received specification list.

10. The method of claim 8, wherein the mock server, when implemented, provides endpoints through which the end user may communicate.

11. The method of claim 8, further comprising:
receiving an adjustment in configuration settings for the mock server; and
adjusting one or more aspects of the mock server based on the received adjustment.

12. The method of claim 11, wherein the adjustment in the configuration settings changes a rate at which the mock server can process request calls.

13. The method of claim 8, further comprising:
receiving instructions to force a state on the mock server; and
causing, based on the received instructions, the mock server to enter into the state indicated in the received instructions,
wherein the mock server, when forced into the state, provides a set of responses that corresponds to the forced state.

14. The method of claim 8, wherein the request calls are made by the end user in one of a production environment or a live environment, and the responses to the request calls are generated by one of a test environment or a live server of the third-party vendor,
the method further comprising:
comparing the responses generated by the test environment to the responses generated by the live server to identify differences; and
generating a message to the third-party vendor to inform the third-party vendor about the identified differences.

15. A non-transitory machine-readable medium having stored thereon machine-readable instructions executable to cause performance of operations comprising:
receiving a data log from the production testing server;
intercepting request calls being sent from a production testing server to a third-party testing environment;
intercepting responses to the request calls generated by and sent from the third-party testing environment to the production testing server;
analyzing the request calls and the responses;
building a mock server based on the received data log;
modifying the mock server based on the analyzing; and
implementing the mock server as a testing platform, the mock server being able to receive the request calls and provide mock responses.

16. The non-transitory machine-readable medium of claim 15, wherein intercepted responses are stored in a database of the mock server.

17. The non-transitory machine-readable medium of claim 15, wherein the mock responses are selected from the responses stored on the database.

18. The non-transitory machine-readable medium of claim 15, wherein the operations further comprise receiving documentation provided by the third-party testing environment, wherein the mock server is built based further on the received documentation.

19. The non-transitory machine-readable medium of claim 15, wherein the operations further comprise:
receiving instructions to force a state on the mock server; and
causing, based on the received instructions, the mock server to enter into the state indicated in the received instructions,
wherein the mock server, when forced into the state, provides a set of responses that corresponds to the forced state.

20. The non-transitory machine-readable medium of claim 19, wherein the state being forced is a state provided in the documentation.
